(19) United States
(12) Patent Application Publication
(10) Pub. No.: US 2007/0208571 A1
(43) Pub. Date: Sep. 6, 2007

(54) Audio Bitstream Format In Which The Bitstream Syntax Is Described By An Ordered Transversal of A Tree Hierarchy Data Structure

(76) Inventor: Pierre-Anthony Stivell Lemieux, San Mateo, CA (US)

Correspondence Address: GALLAGHER & LATHROP, A PROFESSIONAL CORPORATION, 601 CALIFORNIA ST, SUITE 1111, SAN FRANCISCO, CA, 94108, US

(21) Appl. No.: 11/578,353

(22) PCT Filed: Apr. 13, 2005
(86) PCT No.: PCT/US05/12493

§ 371 Date: Oct. 11, 2006

Related U.S. Application Data
(60) Provisional application No. 60/564,465, filed on Apr. 21, 2004.

(51) Int. Cl. G10L 21/00

(52) U.S. Cl. 704/500

(57) ABSTRACT

A bitstream format for representing audio information in which the bitstream syntax is described by an ordered transversal of a tree hierarchy data structure, has a tree hierarchy comprising a plurality of tree hierarchy levels, each having one or more nodes, in which at least some progressively smaller subdivisions of the audio information are represented in progressively lower levels of the tree hierarchy, wherein the audio information is included among nodes in one or more of said levels.

### TECHNICAL FIELD

The invention relates to a bitstream format for representing audio information in which the bitstream syntax is described by an ordered transversal of a tree hierarchy data structure, to a bitstream formatted in accordance with such a bitstream format, to a medium for storing or transmitting such a bitstream, to a system for encoding and decoding a bitstream having a format in accordance with such a bitstream format, to an encoder for encoding a bitstream having a format in accordance with such a bitstream format, to an decoder for decoding a bitstream having a format in accordance with such a bitstream format, to a process for encoding and decoding a bitstream having a format in accordance with such a bitstream format, to a process for generating a bitstream formatted in accordance with such a bitstream format, to a process for encoding a bitstream having a format in accordance with such a bitstream format, and to a process for decoding a bitstream having a format in accordance with such a bitstream format.

### DISCLOSURE OF THE INVENTION

In accordance with an aspect of the present invention, a bitstream format for representing audio information in which the bitstream syntax is described by an ordered transversal of a tree hierarchy data structure, has a tree hierarchy comprising a plurality of tree hierarchy levels, each having one or more nodes, in which at least some progressively smaller subdivisions of the audio information are represented in progressively lower levels of the tree hierarchy, wherein the audio information is included among nodes in one or more of said levels. The progressively smaller subdivisions of the audio may include one or more of temporal subdivisions, spatial subdivisions, and resolution subdivisions. A first level of the tree hierarchy may comprise a root node representing all of the audio information, at least one lower level may comprise a plurality of nodes representing a time segmentation of the audio information and at least one further lower level may comprise a plurality of nodes representing a spatial segmentation of the audio information. Alternatively, or in addition, the audio information may be layered to provide multiple resolutions, such that a base resolution audio information layer is contained in one level and one or more audio information resolution enhancement layers are contained in the same layer or one or more other levels. Other aspects of the invention are set forth throughout this written description and claims.

A bitstream format in accordance with aspects of the present invention may be useful in one or more of:
minimizing audio processing latency,
adding, removing and otherwise manipulating metadata without extensive modifications to a bitstream
associating arbitrary metadata with specific aspects of the audio material contained in a bitstream
minimizing bitstream structural overhead,
providing a flexible bitstream structure for forward/backward compatibility,
enabling efficient transport over a variety of interfaces,
facilitating time-based editing, and
facilitating encapsulation of encoded or unencoded audio information.

Definitions and examples of tree hierarchy data structures may be found at the NIST, National Institute of Standards and Technology, website's “Dictionary of Algorithms and Data Structures” (http://nist.gov/dads/). A demonstration of a preorder traversal of a tree hierarchy data structure may be found at the Department of Computer Science, University of Canterbury (New Zealand) website's Data Structures, Algorithms, Binary Tree Traversal Algorithm (http://www.cosc.canterbury.ac.nz/people/mukundan/dsal/BTree.html).

### DESCRIPTION OF THE DRAWINGS

FIGS. 1a and 1b are simplified schematic representations showing, respectively, the audio information (sometimes referred to herein as “audio essence”) components of a bitstream and a hierarchical tree representation of that bitstream in accordance with aspects of the present invention.

FIG. 2 is a simplified schematic representation showing an example of a hierarchical tree representation similar to FIG. 1b, but which also includes metadata.

FIG. 3 is a simplified schematic representation showing a bitstream that has been serialized, in accordance with aspects of the present invention, as a result of an ordered traversal of the tree hierarchy of FIG. 2. FIG. 2 differs from FIG. 1b in that it also shows segments of metadata attached to the start and/or end of each node.

FIGS. 4a through 4d are simplified schematic representations showing a transcoding process using a bitstream in accordance with aspects of the present invention.

FIG. 5 is a simplified schematic representation of the structure of a node in the tree hierarchy in accordance with aspects of the present invention.

FIG. 6 is a simplified schematic representation of the structure of a short node.

FIG. 7 is a simplified schematic representation of an example of a hierarchical tree in accordance with the present invention.

FIG. 8A is a simplified schematic representation showing the mapping of two AC-3 sync frames to a bitstream in accordance with aspects of the present invention.

FIG. 8b is a simplified schematic representation showing the AC-3 encapsulating bitstream of FIG. 8a with the addition of two supplementary audio channels.

FIG. 9 is a simplified schematic representation in the nature of a flowchart or functional block diagram, showing various functional aspects of an encoder or encoding process for generating a bitstream similar to that of the FIG. 3 example, in accordance with aspects of the present invention.

FIG. 10 is a simplified schematic representation in the nature of a flowchart or functional block diagram, showing various functional aspects of a decoder or decoding process for deriving audio essence and metadata from a bitstream such as that of the FIG. 3 and FIG. 9 examples, in accordance with aspects of the present invention.

### BEST MODE FOR CARRYING OUT THE INVENTION

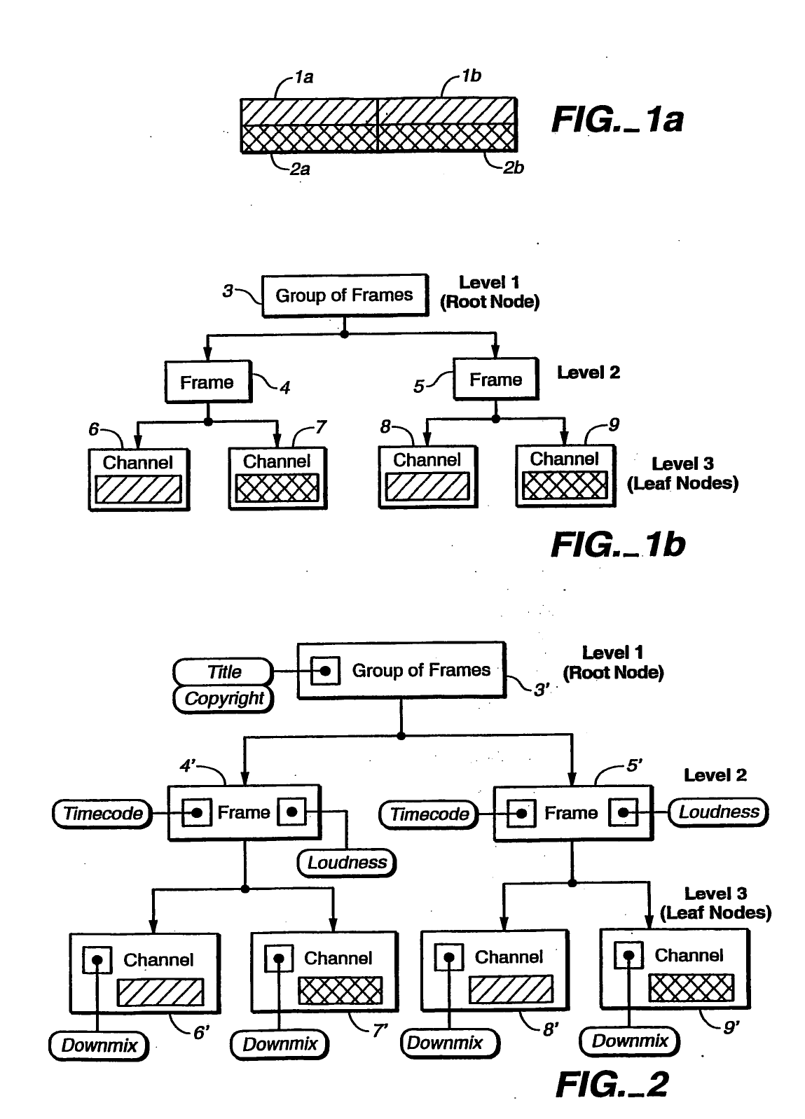

FIGS. 1a and 1b are simplified schematic representations showing, respectively, the audio information (sometimes referred to herein as “audio essence”) components of a bitstream and a hierarchical tree representation of that bitstream in accordance with aspects of the present invention. The bitstream representation of FIG. 1a shows two consecutive audio frames, each having first and second channels, channel 1 and channel 2. The latter may correspond, for instance, to audio information to be reproduced by Left and Right speaker, respectively. Channels 1 and 2 are labeled 1a and 2a in the first frame and 1b and 2b in the second frame. In FIG. 1a, the vertical direction represents channels and the horizontal direction represents frames and time.

In the example of FIG. 1b, a tree hierarchy underlying the bitstream of FIG. 1a according to aspects of the invention, has three levels: level 1, level 2 and level 3. A single root node 3 in level 1 represents the entire bitstream's audio material. In practice, as described below, the bitstream format and underlying tree hierarchy data structure representation of the “audio material” may include audio information or audio “essence,”“metadata,” which is information about the audio essence and other data. However, in this simple example, only the audio essence is shown with respect to the bitstream's tree hierarchy.

At level 2 of the hierarchy of this example, the audio material may be decomposed into any number of individual audio frames, each having fixed or variable durations or bit lengths (for simplicity in presentation, only two frames are shown in the example of FIGS. 1a and 1b). Frame nodes 4 and 5, each with the root node 3 as its parent, represent the first and second audio frames, respectively, at level 2 of the hierarchy of this example. Each audio frame may be decomposed into any number of audio channels (for simplicity in presentation, only two channels per frame are shown in the example of FIGS. 1a and 1b), each corresponding to a spatial direction, for example, such as “left” and “right.”. Channel nodes 6, 7, 8 and 9, each with the frame node it belongs to as its parent, represent, respectively, audio channels 1a, 2a, 1b and 2b in the successive frames at level 3 of the hierarchy.

In the example of FIG. 1b, channel nodes 6-9 are leaf nodes and each contains audio essence in the form of at least one essence element. Although, in principle, the audio essence need not be contained in the leaf nodes, in practice there are advantages in placing the audio essence in the leaf nodes (and, in the case of “layered” audio such as where a base resolution layer of audio is provided along with one or more higher-resolution enhancement layers, placing the audio essence in the leaf nodes and in the nodes of one or more next higher hierarchical layers), as will be appreciated as the description of the invention is read and understood.

Wherever it may be located in the hierarchy, it is an aspect of the present invention that audio essence is in one or more nodes of the hierarchy and, consequently, that audio essence is present in the resulting bitstream. This does not preclude the possibility, for example, that information relevant to the encoding or decoding or audio essence may be located other than in the bitstream and its underlying hierarchy. For example, a pointer in metadata associated with audio essence could point to a particular decoding process external to the bitstream and its underlying hierarchy.

As indicated above, the bitstream format and underlying tree hierarchy data structure representation of the “audio material” may include not only audio information or audio “essence,” but also “metadata,” which is information about the audio essence and other data.

Useful discussions about audio metadata include “Exploring the AC-3 Audio Standard for ATSC” in Audio Notes by Tim Carroll, Jun. 26, 2002, at http://tvtechnology.com/features/audio_notes/f-TC-AC3-06.26.02.shtml, “A Closer Look at Audio Metadata” in Audio Notes by Tim Carroll, Jul. 24, 2002, at http://tvtechnology.com/features/audio_notes/f-tc-metadata.shtml and “Audio Metadata: You Can Get There From Here” in Audio Notes by Tim Carroll, Aug. 21, 2002, at http://tvtechnology.com/features/audio_notes/f-TC-metadata-08.21.02.shtml. Each document is hereby incorporated by reference in its entirety.

A bitstream based on a hierarchical representation in accordance with aspects of the present invention allows arbitrary metadata information to be precisely associated and hence synchronized, with the audio essence it describes. This may be accomplished by locating the metadata to be associated with particular audio essence in the same node as the audio essence or in any parent node of a node containing the audio essence. According to embodiments of the invention, as described further below, one or more metadata elements may be attached to the start or end of any node within the hierarchy. Thus, in a three level hierarchy such as in the example of FIG. 1b, metadata associated with particular audio essence may be attached to the start or end of the entire bitstream's audio material in the root node of level 1, the start or end of an individual frame in a frame node in level 2 that is a parent of a channel containing the particular audio essence, and/or the start or end of the channel in a channel (leaf) node in level 3 that contains the particular audio essence. Examples of such arrangements are shown below in the example of FIG. 2.

Preferably, metadata is distributed among the hierarchy levels in a manner that contributes to the “semantic independence” of individual nodes. For example, in a FIG. 1b type arrangement, metadata in the root node preferably applies only to the entire audio material, metadata in a frame node preferably applies only to a particular frame and its channels, and metadata in a channel node preferably applies only to a particular channel. By proper definition of the metadata information, one can ensure that the manipulation of a given node does not require modification of metadata carried in another node. For example, given that a frame node contains no metadata specific to any particular channel node and that a channel node contains no metadata required by another channel node, then not only the metadata in a channel node but also a channel node in its entirety may be added, removed or modified without modification to metadata located in another node. In this sense, aspects of the present invention allow nodes to be semantically independent. In other words, from a metadata and essence perspective, any given node can be independent from its siblings if it contains metadata applicable only to itself and to all its children (if any) equally. Consequently, a bitstream according to the present invention having appropriately distributed metadata may facilitate transcoding, as explained further below.

A bitstream in accordance with the present invention is generated using an ordered traversal of a tree hierarchy data structure to serialize the hierarchical representation of the audio material. Preferably, the ordered traversal is in the nature of a preorder traversal (sometimes referred to as “prefix traversal”). A preorder traversal algorithm may be defined as: process all nodes of a tree by processing the root node, then recursively processing all subtrees. In particular, if no body tags are employed (see below regarding “body tags”), a suitable preorder traversal algorithm for use in serializing a hierarchy in accordance with aspects of the present invention may be described by applying the following algorithm, starting with the root node:
a) A “start tag” segment indicating the start of node may be written to a bitstream;
b) each of the one or more metadata or essence elements attached to the start of node may then be written as an individual segment;
c) the algorithm, starting with step “a” is applied to each of the children nodes of the node under consideration;
d) each of the one or more metadata or essence elements attached to the end of node may then be written as an individual segment; and
e) an “end tag” segment indicating the end of node may be written to a bitstream.

The traversal algorithm may also be expressed in a simplified C-language pseudocode as follows:

visit(root);

where

visit(node) {

for segment in node.header.segments do {

write(segment);

}
for child in all node.children do {

visit(child);

}
for segment in node.footer.segments do {
write(segment);
}

}

If body tags are employed, a suitable preorder traversal algorithm may be described by applying the following algorithm, starting with the root node:
a) A “start tag” segment indicating the start of node may be written to a bitstream.
b) each of the one or more metadata or essence elements attached to the start of node may then be written as an individual segment,
c) if the root node has no children nodes and no metadata or essence elements attached to its end then steps d) through and including g) may be skipped.
d) a “start body tag” segment indicating the start of the children node of node may be written to a bitstream,
e) the algorithm, starting with step “a” is applied to each of the children nodes of the node under consideration,

f) an “end body tag” segment indicating the end of the children node of node may be written to a bitstream,

g) each of the one or more metadata or essence elements attached to the end of the node may then be written as an individual segment, and

h) an “end tag” segment indicating the end of the node may be written to a bitstream.

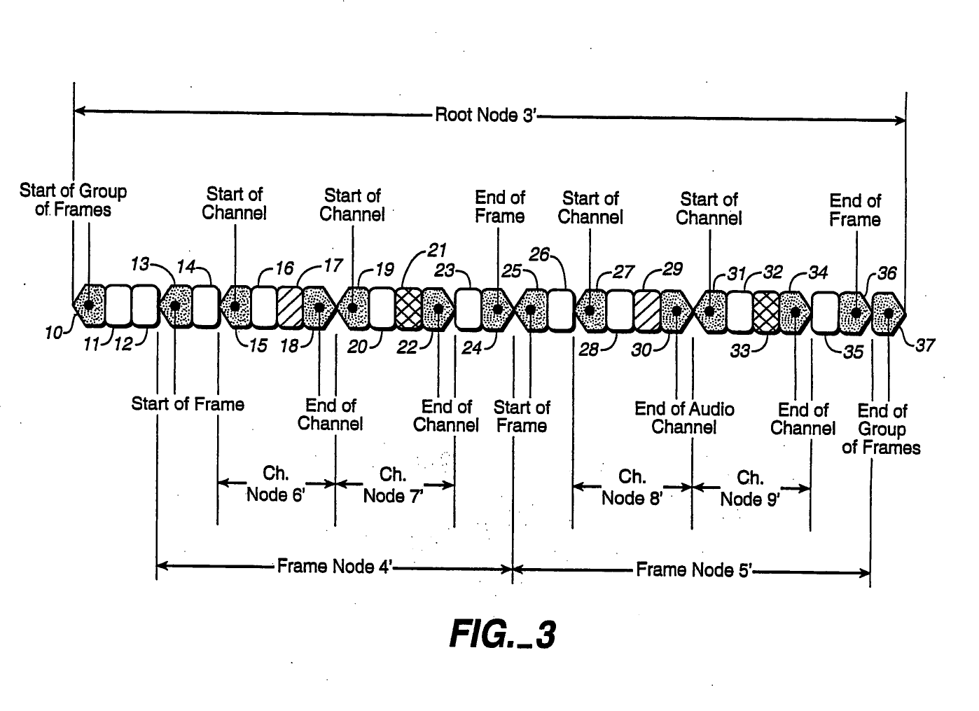

FIG. 2 shows a simple example of a hierarchical tree representation similar to FIG. 1b, but which also includes metadata. FIG. 3 shows a bitstream that has been serialized as a result of an ordered traversal of the tree hierarchy of FIG. 2.

FIG. 2 differs from FIG. 1b in that it also shows segments of metadata attached to the start and/or end of each node. To indicate that the nodes are modifications of the nodes of FIG. 1b, reference numerals having a prime symbol are used in FIG. 2. Thus, root node 3′ has, for example, title and copyright metadata attached to its start. Frame nodes 4′ and 5′ have, for example, timecode attached to the start of each node and loudness metadata attached to the end of each node. Channel nodes 6′, 7′, 8′ and 9′ have, for example, downmix metadata attached to the start of each node.

FIG. 3 shows an example of a bitstream that has been serialized in accordance with an algorithm and hierarchy according to the present invention. The bitstream has segments (a segment may also be referred to as an “atomic element”) 10 through 37 that result from an ordered traversal of the FIG. 2 hierarchy in accordance with the “no body-tags” algorithm above. Each element, whether containing audio essence, metadata, or other data, preferably is labeled using a unique identifier indicating its content Suitable identifiers are described below.

As further described below, the root node 3′ includes segments 10 through 37, all of the audio material. The nesting of the frame nodes 4′ and 5′ within the root node 3′ and, in turn, the nesting of the channel nodes within each of the frame nodes may be seen in FIG. 3. The bitstream of the example of FIG. 3 begins with a root node start tag segment 10, indicating the start of the audio material, followed by a metadata (title) segment 11 and a metadata (copyright) segment 12, attached to the start of the root node. Then the first child, frame node 4′ is visited as indicated by frame node start tag 13 followed by a metadata (timecode) segment 14 attached to the start of the frame node 4′. Next, the first child, channel node 6′, of frame node is visited as indicated by channel node start tag 15. The channel node start tag segment is followed by a metadata (downmix) segment 16 attached to the start of the channel node 6′. The metadata segment 16 is followed by the (channel 1) audio essence 17 of channel node 6′ and a channel node end tag 18. Next, the second child, channel node 7′, of frame node 4′ is visited as indicated by channel node start tag 19. The channel node start tag segment is followed by a metadata (downmix) segment 20 attached to the start of the channel node 7′. The metadata segment 20 is followed by the (channel 2) audio essence 21 of channel node 7′ and a channel node end tag 22. Since there are no other children of frame node 4′ and since channel nodes 6′ and 7′ are leaf nodes, frame node 4′ is revisited, allowing the writing of the loudness metadata. 23 (the loudness metadata depends on the process having visited the audio essence of channels 1 and 2 in order to determine the value of the loudness metadata). An end of frame tag segment 24 is then written to the bitstream. The next frame node 5′ is then visited.

In a similar manner as just described for the subtree of frame node 4′, the bitstream resulting from frame 5′ and its children, leaf nodes 8′ and 9′ are written, producing frame start segment 25, metadata (timecode) segment 26, channel node start tag 27, channel node metadata (downmix) segment 28, (channel 1) channel node audio essence segment 29, channel node end tag 30, channel node start tag 31, channel node metadata (downmix) segment 32, (channel 2) channel node audio essence segment 33, channel node end tag 34, frame node end metadata (loudness) 35 and end of frame tag segment 36. Because this simple example has only two frames, the root node is then revisited. Inasmuch as there is no metadata attached to the end of the root node, the root node end tag segment 37 is written, indicating the end of the audio material.

In addition to being semantically independent, as mentioned above, each segment is structurally independent in the sense that each segment contains its own type and length, does not contain other segments, nor is it nested within another segment. Therefore a segment may be processed without a priori knowledge of other segments, and as a corollary, the bitstream may be parsed one segment at a time, thereby allowing low latency operation. Furthermore, addition, deletion and modification of a node or segment do not necessarily require the manipulation of any other node or segment.

Given such structural flexibility, segments, and in fact entire nodes, may be added, removed and manipulated without affecting other segments and nodes, provided that metadata and audio essence are distributed optimally. This allows, for example, the removal of a particular audio channel from some audio material without necessitating remastering of the bitstream in its entirety. In particular, nodes preferably do not contain any length or synchronization information that may require systematic modification (i.e., modification in other nodes of the bitstream). Length information is not required because start tags and end tags delimit the node. Synchronization information is not required because the presence of a segment within a node explicitly synchronizes it with the content of the node. On the other hand, metadata and/or audio essence could be distributed in such a manner as to introduce dependence among, for example, nodes at a particular level of the hierarchy, in which case latency would be increased. For example, a particular embodiment of aspects of the invention could require that each frame node contain a timestamp and that timestamps be continuous. The removal of one frame node would then require modifying all subsequent frame nodes, an undesirable design decision.

As indicated above, each element within the hierarchy, whether containing audio essence, metadata, or other data, preferably is labeled using a unique identifier indicating its content. A given application receiving a bitstream formatted in accordance with the present invention may therefore ignore elements it does not recognize. This allows new types of elements to be introduced in the bitstream without disturbing existing applications. For example, one or more audio essence enhancement layers, along with related metadata, could be added to a bitstream, permitting both backward and forward compatibility. Alternatively, one or more enhancement layers could be contained in metadata.

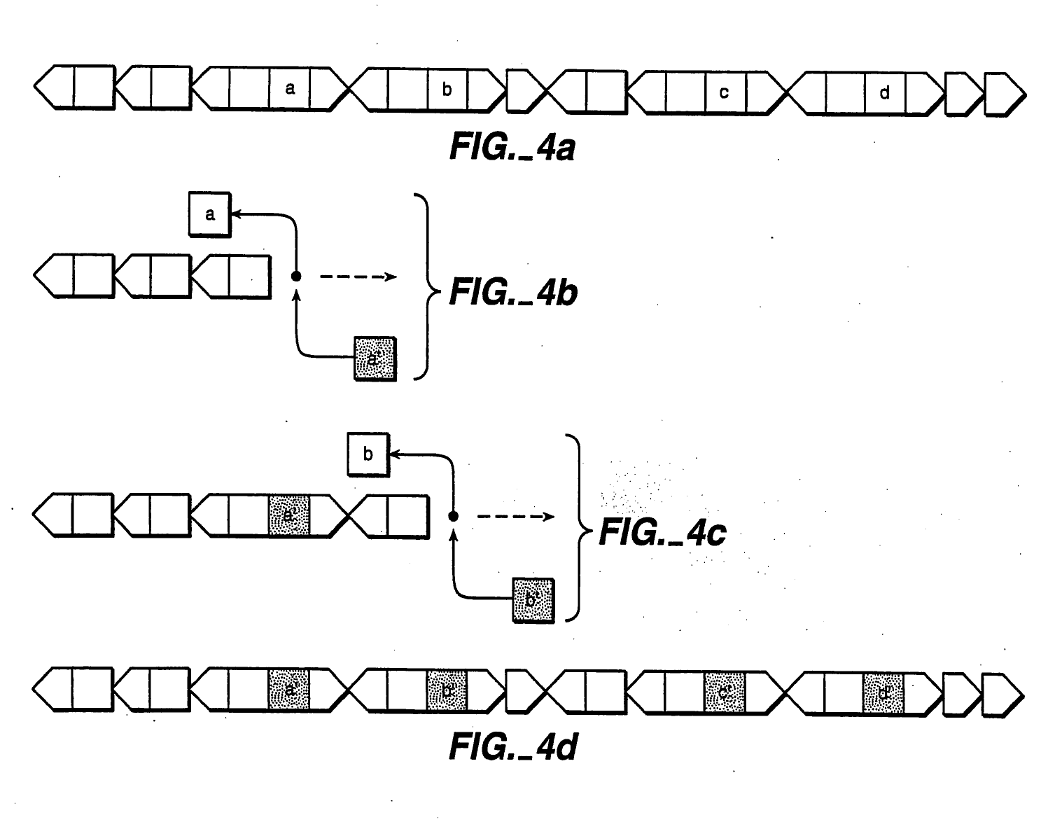

FIGS. 4a through 4d illustrate a transcoding process using a bitstream in accordance with aspects of the present invention. Segments are processed serially as they appear in the bitstream. FIG. 4a, shows a two-channel bitstream according to the present invention prior to a transcoding process. Segments (a) and (b) contain audio information corresponding to channels 1 and 2 of frame 1. Segments (c) and (d) contain audio information corresponding to channels 1 and 2 of frame 2. In FIG. 4b, a tanscoding process has read six segments when it encounters segment (a) containing audio information. It reads the segment from the bitstream, extracts the audio information, transcodes this audio information to a target format, and wraps the audio information back into segment (a′) that it writes to the bitstream in place of (a). Unless channel nodes are mutually dependent in the context of transcoding, no knowledge of previous or future nodes is necessary. This is important for low latency operation—transcoding may begin before the entire bitstream or large portions of the bitstream are received by the transcoding process. In FIG. 4c, the transcoding process reaches segment (b) that it writes as segment (b) in the manner described in connection with FIG. 4b. FIG. 4d shows a fully transcoded bitstream.

The following describes an embodiment of aspects of the present invention. It will be understood that the invention is not limited to this or to other embodiments. Although the following description sets forth the syntax and grammar of a bitstream, the structure of the bitstream's atomic elements, and conforming arrangements of these elements, it does not describe the semantic content of the bitstream, such as the relationship between metadata and audio essence. Such relationships are beyond the scope of the present invention.

Terminology employed herein and, particularly, in connection with this embodiment may be defined as follows:
underlying audio material the audio information represented by a self-contained bitstream comprising nodes and segments and formatted in accordance with aspects of the present invention.
node zero or more consecutive bitstream segments belonging to a hierarchy level and delimited by a start-tag and end-tag pair. Nodes may be nested.
segment (atomic element) the smallest bitstream element that can be manipulated (e.g., packaged or encrypted) as a distinct entity. There are three types of segments: audio essence segments, metadata segments (audio essence and metadata segments are “content” segments) and tag segments (tag segments are “structural” segments that, for example, assist in relating the bitstream and tree hierarchy to each other). A segment may carry information on its length, type, and/or content.
audio essence segment a content segment carrying audio essence (audio information). An audio essence segment may be, for example, a sequence of unencoded pulse code modulation (PCM) audio data or encoded PCM audio data (e.g., perceptually encoded PCM).
metadata segment a content segment carrying metadata information relating to audio essence with which it is associated.
tag segment a non-content segment used to delimit a node.
frame a bitstream node comprising one or more audio essence segments that represent a time interval of the audio material and one or more metadata segments relating to such audio essence segments
group of frames a sequence of frames preceded by one or more metadata segments and, optionally, followed by one or more additional metadata segments.

A bitstream formatted in accordance with the present invention is defined independently from audio coding, audio metadata, and method of port, and, as such, may not include features such as error correction and compression-specific metadata.

### Segments

As indicated above, a segment or atomic element is the smallest bitstream element that can be manipulated (e.g., packaged or encrypted) as a distinct entity. In practice, each segment may be a byte-aligned structure comprising a header, containing type and size information, and, in the case of audio essence and metadata segments, a payload. Tag segments carry structural information and have no payload. Content segments carry metadata or essence information as their payload. The type of a segment and its semantic significance may be refined further by using unique identifiers. Segment syntax is specified in more detail below.

### Nodes

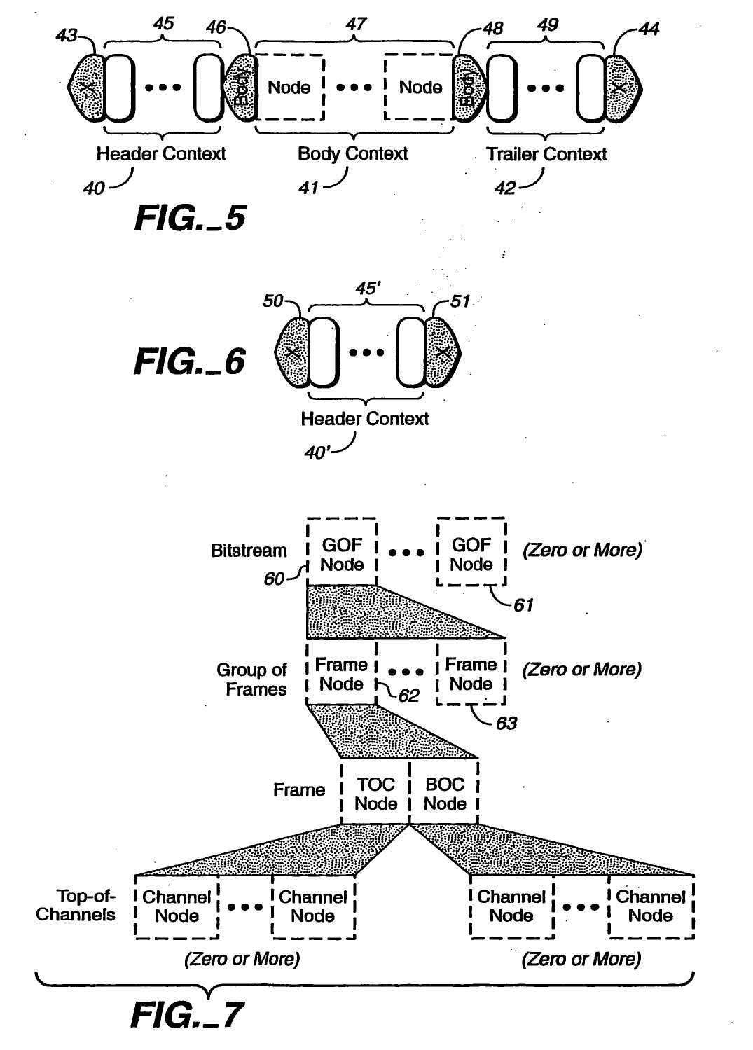

Segments are further arranged into nodes, which are hierarchical nested structures. In the present embodiment, a node may consist of a sequence of segments bounded by matching start- and end-tag segments. As shown in FIG. 5, the structure of a node in the tree hierarchy contains three distinct contexts (or portions): header 40, body 41, and trailer 42 contexts. The header and trailer contexts may each contain one or more content segments, while the body context contains zero or more children nodes. Optionally, the body context may be bounded by body start- and end-tag segments.

Referring to the details of FIG. 5, the node structure begins with a start-tag segment 43 and ends with an end-tag segment 44. The tag segments 43 and 44 each are marked “X” because the type of tag depends on the location of the node in the hierarchy. In the case of a root node in the present embodiment, the tag segments may be a group of frame (GOF) tags. Following the start tag 43, the header context 40 may have one or more content segments 45. Next, a body start tag 46 may delimit the beginning of the body context 41 containing one or more nodes 47 nested in one or more hierarchical levels below the node shown in FIG. 5. A body end-tag 48 may delimit the end of the body context 41. Following the body end tag 48, the trailer context 42 may have one or more content segments 49. Finally, the node structure ends with the end-tag segment 44.

If both the body and trailer contexts are empty, as may occur in the case of a leaf node containing audio essence and, possibly, related metadata, then the body tags may be omitted and the node becomes a short node, as depicted in FIG. 6. A short node is limited to a header context 40′ because header and footer contexts cannot be differentiated in the absence of body tags. Referring to the details of FIG. 6, the node structure begins with a start-tag segment 50 and ends with an end-tag segment 51. As in the case of the FIG. 5 example, the tag segments are marked “X” because the type of tag depends on the location of the node in the hierarchy. In the case of a leaf node in the present embodiment, the tag segments may be channel tags. The header context 40′ is between the start- and end-tags and comprises one or more content segments 45′.

### Hierarchical Structure

The hierarchical structure of the bitstream may be specified by the structure of the body context of the nodes. The contents and semantics of header and trailer contexts associated with nodes are specific to environments in which the bitstream format of the present invention is employed and do not form a part of the present invention.

In order to facilitate extensibility, out-of-context content segments and nodes may be skipped and ignored by an application that receives and processes a bitstream formatted in accordance with aspects of the present invention. However, in-context but out-of-order nodes may be treated as errors. “In-context” refers to segments and nodes that have been defined as belonging to a particular node context. For example, as discussed below, the top-of-channel (TOC) node is in-context when present in the frame body but would be out-of-context if present in the GOF node. Such approaches facilitate forward compatibility by allowing future applications to insert additional content segments and nodes while retaining compatibility with older applications.

As shown in FIG. 7, a bitstream according to aspects of the present invention is a hierarchical structure with a sequence of one or more group of frames (GOF) nodes at its root. Only GOF nodes are in-context in the root node of this example.

### Group of Frames (GOF) Nodes

A GOF node 60 . . . 61 (FIG. 7) is an entity that contains the information necessary to accurately reproduce a portion of the audio material carried by the bitstream. Frame nodes are nested within each GOF node.

Ideally, a GOF node contains sufficient information so that bitstreams may be easily manipulated (e.g., spliced) on a GOF boundary.

| | |
|---|---|
| Node Name | GOF |
| tag_id | (see below) |
| In-Context Nodes | Frame |
| Body Structure | zero or more Frame nodes |

### Frame Node

A frame node 62 . . . 63 (FIG. 7) comprises audio essence and metadata information corresponding to a time interval. One top-of-channels (TOC) node and one bottom-of-channels (BOC) node may be nested within each frame node. The metadata present at the frame level may complement that already found at the GOF level and may be susceptible to change across frame nodes. Frame nodes may be independent if the metadata at the frame level does not change across frames. Although not a requirement, frames may be synchronized with accompanying picture essence. Alternatively, channels may be grouped into more than two nodes or the channels may be nested directly under each frame node such that channel nodes are the in-context nodes.

| | |
|---|---|
| Node Name | Frame |
| tag_id | (see below) |
| In-context nodes | TOC and BOC |
| Body Structure | one TOC node followed by one BOC node |

### TOC and BOC Nodes

The TOC and BOC nodes may each contain the metadata and essence information corresponding to approximately half of the information contained in a frame. Such an arrangement may reduce latency by allowing encoders and decoders to start processing a frame before it has been received or transmitted in its entirety. The TOC and BOC body contexts contain zero or more channel nodes.

| | |
|---|---|
| Node Name | TOC (Top of Channels) |
| tag_id | (see below) |
| In-Context Nodes | Channel |
| Body Structure | zero or more Channel nodes |
| Node Name | BOC (Bottom of Channels) |
| tag_id | (see below) |
| In-Context Nodes | Channel |
| Body Structure | zero or more Channel nodes |

### Channel Node

Each channel node may represent a single, independent essence entity, and typically contains one or more essence segments accompanied by zero or more metadata segments. In this bitstream format embodiment, the body of the channel node is empty and, if no trailer is defined, the node structure may take the short node form.

| | |
|---|---|
| Node Name | Channel |
| tag_id | (see below) |
| In-Context Nodes | <none> |
| Body Structure | <empty> |

### Segment Specification

Segments may be specified in more detail by way of the following pseudo code, based on simplified C language syntax. For chunk elements that are larger than 1 bit, the order of arrival of the bits is always MSB first. Fields or elements contained in the frame are indicated in bold type.

///
///
///
///
///
///
///
///

| Syntax | | word size (bits) |
|---|---|---|
| segment( ) | | |
| { | | |
| | is_tag | 1 |
| | if (class == tag) | |
| | { | |

| | |
|---|---|
| start_or_end | 1 |
| is_long_id | 1 |
| if (is_long_id) | |
| { | |

| | |
|---|---|
| tag_id | 13 |

}
else
{

| | |
|---|---|
| tag_id | 5 |

}

}
else
{

| | |
|---|---|
| metadata_or_essence | 1 |
| is_long_id | 1 |
| if (is_long_id) | |
| { | |

| | |
|---|---|
| content_id | 13 |

}
else
{

| | |
|---|---|
| content_id | 5 |

| | |
|---|---|
| } | |
| content_length_class | 2 |
| content_length | (content_length_class + 1) * 8 − 2 |
| content_payload | variable |

}

}

### Tag Segment Parameters

### “is_tag” Parameter

Word size: 1

Valid range: 1

A tag segment always has an is_tag value of 1.

### “start_or_end” Parameter

Word size: 1

Valid range: 0 (start), 1 (end)

The value of this parameter indicates whether the tag is a start tag (0) or end tag (1).

### “is_long_id” Parameter

Word size: 1

Valid range: 0 (5-bit id field), 1 (13-bit id field)

The value of this parameter indicates whether the tag_id field is 5-bit or 13-bit wide.

### “tag_id” Parameter

Word size: 5 or 13 (see previous parameter)

Valid range: [0 . . . 31] or [0 . . . 2¹³_-1]

The value of this parameter indicates which tag the segment represents. The following tags may be defined:

| tag | tag description |
|---|---|
| 0 | frame tag |
| 1 | top of channels (toc) tag |
| 2 | bottom of channels (boc) tag |
| 3 | channel tag |
| 4 | group of frames (gof) tag |
| 5 | body tag |

### Content Segment Parameters

### “is_tag” Parameter

Word size: 1

Valid range: 0

A content segment always has an is_tag value of 0.

### metadata_or_essence Parameter

Word size: 1

Valid range: 0 (metadata), 1 (essence)

The value of this parameter indicates whether the segment contains metadata (0) or essence (1).

### “is_long_id” Parameter

Word size: 1

Valid range: 0 (5-bit id field), 1 (13-bit id field)

The value of this parameter indicates whether the content_id field is 5-bits or 13-bits wide.

### “content_id” Parameter

Word size: 5 or 13 (see previous parameter)

Valid range: [0 . . . 31] or [0 . . . 2¹³−1]

The value of this parameter uniquely identifies the type of information contained within the segment.

### “content_length_class” Parameter

Word size: 2

Valid range: [0 . . . 3]

The content_length_class parameter may determine, according to the following table, the maximum length of the segment.

| content_length class | content_length parameter depth |
|---|---|
| 0 | 6 bits |
| 1 | 14 bits |
| 2 | 22 bits |
| 3 | 30 bits |

### “content_length” Parameter

Word size: (content_length_class+1)*8−2

Valid range:

[0 . . . 63] (content_length_class=0)
[0 . . . 16383] (content_length_class=1)
[0 . . . 2´22] (content_length_class=2)
[0 . . . 2´30] (content_length_class=3)
   The content_length parameter determines the total length, in bytes, of the payload.

### Example of Encapsulation of AC-3 Serial Coded Audio Bitstreams

As mentioned above, encoded audio information may be encapsulated as segments of a bitstream formatted according to aspects of the present invention. As an example thereof, the essential portions of an AC-3 serial coded audio bitstream may be encapsulated in the following manner.

The AC-3 digital audio compression standard is described in ATSC Standard: Digital Audio Compression (AC-3), Revision A, Document A/52A, Advanced Television Systems Committee, 20 Aug. 2001 (the “A/52A Document”). The A/52A Document is hereby incorporated by reference in its entirety.

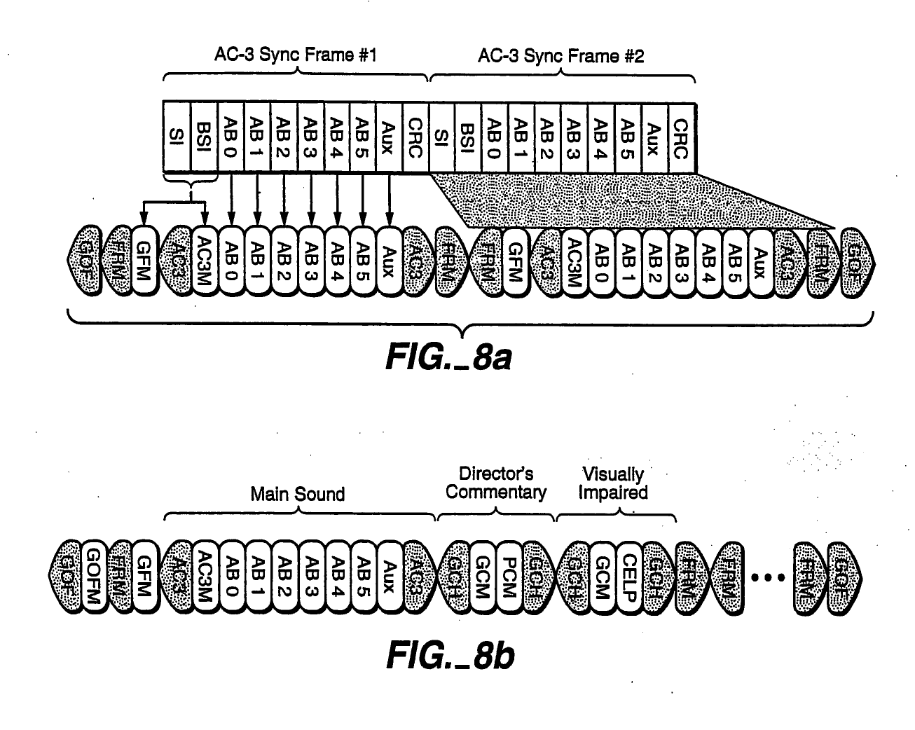

The AC-3 bitstream syntax is described in Section 5 (and elsewhere) of the A/52A Document. An AC-3 serial coded audio bitstream is made up of a sequence of synchronization frames (“sync frames”). FIG. 8A shows the mapping of two AC-3 sync frames to a bitstream in accordance with aspects of the present invention. Each AC-3 sync frame contains six coded audio blocks (AB0 through AB5), each of which represent 256 new audio samples. A synchronization information (SI) header at the beginning of each frame contains information needed to acquire and maintain synchronization. A bitstream information (BSI) header follows SI, and contains parameters describing the coded audio service. The coded audio blocks may be followed by an auxiliary data (Aux) field. Often, the auxiliary data comprises null “padding” bits required to adjust the bit length of an AC-3 frame. However, in some cases, the auxiliary data contains information. At the end of each frame is an error check field that includes a CRC word for error detection. An additional CRC word is located in the SI header, the use of which is optional.

FIG. 8a depicts the mapping of two AC-3 sync frames into a bitstream composed of one group of frames node, itself composed of two frame nodes, each representing one or more AC3 channels. The metadata items contained in the SI and BSI headers are divided into two groups, namely (1) metadata items generic to the frame, e.g., timecode, and (2) metadata specific to AC3 and each of its channels. Generic metadata is wrapped into a “GPM” metadata segment, and specific metadata into an “AC3M” metadata segment. The Aux block is wrapped in an Aux segment if it contains user bits—if used for padding only, it may be omitted. Because a given bitstream may travel across a variety of interfaces, some of which may provide their own error correction mechanism, error correction and detection information may be omitted (the CRC block may be omitted) (shown omitted).

More particularly, in FIG. 8a, two AC-3 sync frames are shown, each including in order SI, AB0 through AB5, Aux and CRC elements. The bitstream according to aspects of the present invention, to which the two AC-3 sync frames are mapped for encapsulation, includes a GOF start tag followed by a frame start tag (FR, generic frame metadata (GFM), an AC-3 channel start tag (AC3), AC-3 specific metadata (AC3M), AC-3 content segments (AB0 through AB5 and Aux), an AC-3 channel end tag (AC3), a frame end tag (FRM), and the same sequence mapped from the second AC-3 sync frame.

FIG. 8b depicts the AC-3 encapsulating bitstream of FIG. 8a with the addition of two supplementary audio channels. Each channel may be contained in a Generic Channel (GCH) node. The first channel may contain a Directors Commentary (DC) channel, which may comprise linear PCM samples. A Generic Channel Metadata (GCM) segment identifies this channel as containing a DC channel. The second channel may contain a Visually Impaired (VI) channel, which may consist of Code-Excited Linear Prediction (“CELP”) (a lossy encoded voice audio format) encoded audio. Again, a Generic Channel Metadata (GCM) segment may identify the channel as containing VI material. The duration of the audio content contained in each additional channel preferably matches that of the audio content in the AC3 node, which is of constant duration. In addition, metadata identifying the bitstream may be added in a Group of Frames metadata segment (GOFM).

More particularly, in FIG. 8b, the details of the mapped first AC-3 sync frame with the added supplementary director's commentary and visually paired audio channels are shown. The bitstream includes first a GOF start tag followed by metadata identifying the bitstream (GOFM), a frame start tag (FRM), generic frame metadata (GFM), an AC-3 channel start tag (AC3), AC-3 specific metadata (AC3M), AC-3 content segments (AB0 through AB5 and Aux), an AC-3 channel end tag (AC3), a generic channel start tag (GCH), generic channel metadata (GCM), a linear PCM audio essence segment (PCM), a generic channel end tag (GCH), a generic channel start tag (GCH), generic channel metadata (GCM), CELP-encoded audio essence (CELP), a generic channel end tag (GCH), and a frame end tag (FRM). A second frame (shown only in part) repeats the same sequence with the second frame information.

An advantage of the format of the present invention is that the insertion of two additional channels did not require modification to the AC3 data, and could have occurred as the original bitstream was being streamed, i.e., the insertion of the VI channel in the second frame (not depicted) does not require knowledge of the content of the first frame. Furthermore, decoders that are not capable of interpreting VI and/or DC channels, can easily ignore these channels. For example, the VI and DC channels may have been added in a revision to the specification dictating the content of the bitstream. Thus, the bitstream is backwards compatible.

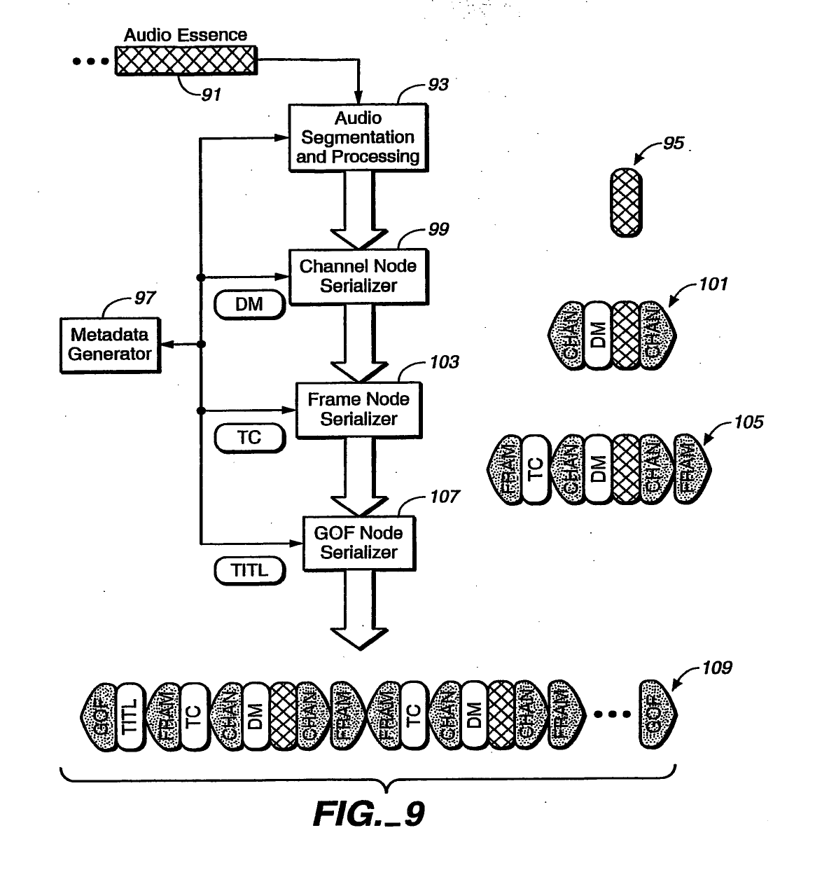

FIG. 9 is in the nature of a flowchart or functional block diagram, showing various functional aspects of an encoder or encoding process for generating a bitstream similar to that of the FIG. 3 example, in accordance with aspects of the present invention. A stream of audio essence 91, which may be samples of linear PCM encoded audio, for example, is applied to an audio segmentation and processing function or device 93 that segments audio into blocks of appropriate duration (fixed or variable) and may apply additional processing such as compression (bit rate reduction encoding, for example). The resulting audio data may be wrapped into audio content segments, one example 95 of which is shown schematically. Information on the audio essence may be fed to a metadata generator 97. The latter uses such information and possibly other information, such as information from a user or from other functions or devices (not shown), to generate metadata segments, which may or may not be synchronized with the audio essence, for insertion into the bitstream.

The audio content segments are then passed on to a channel node serializer function or device 99 that generates a channel node (compare to level 3 of the hierarchy of FIG. 2) containing one or more audio content segments and one or more associated metadata segments (one segment of downmixing (DM) metadata, in this example) obtained from the metadata generator 97, along with channel node start- and end-tags. An example 101 of a channel node is shown schematically as including a channel start-tag (CHAN), do metadata (DM), an audio essence segment, and a channel end-tag (CHAN).

The channel node is fed to a frame node serializer 103 that generates a frame node (compare to level 2 of the hierarchy of FIG. 2) containing the input channel node and associated frame-level metadata (one segment of timecode (TC) metadata, in this example) obtained from metadata generator 97, along with frame node start- and end-tags. An example 105 of a frame node is shown schematically as including a fine start-tag (FRAM) timecode metadata (TC), a channel node sequence, and a frame end-tag (FRAM).

The frame node is fed to a group-of-frames (got) node serializer function or device 107 that combines successive frame nodes and associated metadata one segment of title (TITL) metadata, in this example) obtained from metadata generator 97, along with group-of-frame start and end-tags into a complete bitstream (compare to level 1 of the hierarchy of FIG. 2). An example of a complete bitstream is shown schematically as including a group-of-frames start-tag (GOF), title metadata TITL), two frame sequences, and a group of frames end-tag (GOF).

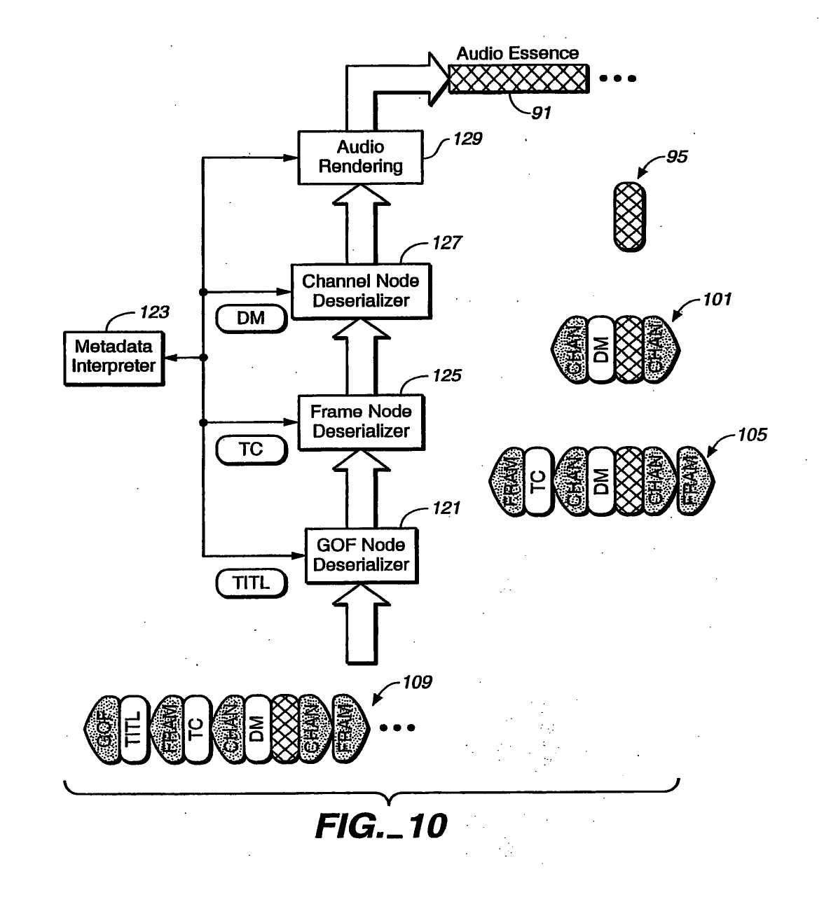

FIG. 10 is in the nature of a flowchart or functional block diagram, showing various functional aspects of a decoder or decoding process for deriving audio essence and metadata from a bitstream such as that of the FIG. 3 and FIG. 9 examples, in accordance with aspects of the present invention.

A bitstream, such as that generated by the FIG. 9 example, is applied to a group-of-frames (gof) node deserializer 121. The gof node deserializer recognizes and removes the gof start- and end-tags and the gof metadata (title (TITL) metadata, in this example), passes the metadata to a metadata interpreter 123, and passes frame nodes to a frame node deserializer 125. An example frame node 105, which may be essentially the same as frame node 105 in FIG. 9, is shown schematically.

The frame node deserializer 125 recognizes and removes the frame node start- and end-tags and the frame metadata (timecode (TC) metadata, in this example), passes the metadata to the metadata interpreter 123, and passes channel nodes to a channel node deserializer 127. An example channel node 101, which may be essentially the same as channel node 101 in FIG. 9, is shown schematically.

The channel node deserializer 127 recognizes and removes the channel node start- and end-tags and the channel metadata (downmix (DM) metadata, in this example), passes the metadata to the metadata interpreter 123, and passes audio essence segments to an audio rendering process or device 129 that reassembles the stream of audio essence 91, which may be essentially the same as the audio essence applied to the encoder or encoding process of FIG. 9.

The metadata interpreter 123 interprets the various metadata and may apply it to functions and/or devices (not shown) and to the audio rendering 129.

The present invention and its various aspects may be implemented in various ways, such as by software functions performed in digital signal processors, programmed general-purpose digital computers, and/or special purpose digital computers. Interfaces between analog and/or digital signal streams may be performed in appropriate hardware and/or as functions in software and/or firmware. Although the present invention and its various aspects may have analog audio signals as their source, most or all processing functions that practice aspects of the invention are likely to be performed in the digital domain on digital signal streams in which audio signals are represented by samples.

A bitstream formatted in accordance with aspects of the present invention may be stored or transmitted by any one or more of known data storage and transmission media.

It should be understood that implementation of other variations and modifications of the invention and its various aspects will be apparent to those skilled in the art, and that the invention is not limited by these specific embodiments described. It is therefore contemplated to cover by the present invention any and all modifications, variations, or equivalents that fall within the true spirit and scope of the basic underlying principles disclosed and claimed herein.

1. A bitstream format for representing audio information in which the bitstream syntax is described by an ordered transversal of a tree hierarchy data structure, the tree hierarchy comprising
a plurality of tree hierarchy levels, each having one or more nodes, in which at least some progressively smaller subdivisions of the audio information are represented in progressively lower levels of the tree hierarchy, wherein said audio information is included among nodes in one or more of said levels.

2. A bitstream format in which the bitstream syntax is described by a tree hierarchy according to claim 1 wherein progressively smaller subdivisions of the audio include one or more of temporal subdivisions, spatial subdivisions, and resolution subdivisions.

3. A bitstream format in which the bitstream syntax is described by a tree hierarchy according to claim 1 wherein a first level of the tree hierarchy comprises a root node representing all of the audio information and at least one lower level comprises a plurality of nodes representing time intervals of the audio information.

4. A bitstream format in which the bitstream syntax is described by a tree hierarchy according to claim 3 wherein at least one further lower level comprises a plurality of nodes representing spatial subdivisions of the audio information.

5. A bitstream format according to any one of claims 1 through 4 wherein said bitstream comprises a sequence of independent tag and content segments, each tag segment functioning as a delimiter, each content segment including a payload carrying audio information or metadata relating to audio information, and wherein said segments are arranged into structurally independent hierarchically nested nodes among levels of said tree hierarchy.

6. A bitstream format according to claim 5 wherein each node is delimited by start- and end-tag segments.

7. A bitstream format according to claim 6 wherein start- and end-tag segments delimit header and footer contexts within a node.

8. A bitstream format according to claim 1 wherein a node containing one or more content segments carrying audio information includes one or more content segments carrying metadata related to the audio information in said one or more content segments carrying audio information.

9. A bitstream formatted in accordance with a bitstream format according to claim 1.

10. A system for encoding and decoding a bitstream a bitstream having a format in accordance with a bitstream format according to claim 1.

11. An encoder for encoding a bitstream having a format in accordance with a bitstream format according to claim 1.

12. A decoder for decoding a bitstream having a format in accordance with a bitstream format according to claim 1.

13. Apparatus for transcoding a bitstream having a format in accordance with a bitstream format according to claim 1.

14. A process for generating a bitstream formatted in accordance with a bitstream format according to claim 1.

15. A process for encoding and decoding a bitstream having a format in accordance with a bitstream format according to claim 1.

16. A process for encoding a bitstream having a format in accordance with a bitstream format according to claim 1.

17. A process for decoding a bitstream having a format in accordance with a bitstream format according to claim 1.

18. A process for transcoding a bitstream having a format in accordance with a bitstream format according to claim 1.

19. A medium for storing or transmitting a bitstream according to claim 9.
